(19) United States
(12) Patent Application Publication
(10) Pub. No.: US 2025/0178599 A1
(43) Pub. Date: Jun. 5, 2025

(54) DRIVING ASSISTANCE DEVICE, DRIVING ASSISTANCE METHOD, AND STORAGE MEDIUM

(71) Applicant: HONDA MOTOR CO., LTD., Minato-ku, Tokyo (JP)

(72) Inventors: Yuji Kaneda, Wako-shi (JP); Ryo Ushiki, Wako-shi (JP); Takuya Furukawa, Wako-shi (JP); Jun Suzuki, Wako-shi (JP)

(21) Appl. No.: 18/842,823

(22) PCT Filed: Mar. 18, 2022
(86) PCT No.: PCT/JP2022/012578

§ 371 Date: Aug. 30, 2024

(51) Int. Cl. B60W 30/09; B60W 10/18; B60W 10/20; B60W 30/095; B60W 50/14; B60W 50/16; G06V 20/56

(52) U.S. Cl. CPC B60W 30/09; B60W 10/18; B60W 10/20; B60W 30/0956; B60W 50/16; G06V 20/588; B60W 2050/143; B60W 2050/146; B60W 2420/403; B60W 2552/53

(57) ABSTRACT

A driving assistance device performs one or both of instructing to stop a vehicle when an approach degree between the vehicle and a target object satisfies a first condition and instructing to avoid coming into contact with the target object by steering, performs a first preliminary operation when the approach degree satisfies a second condition, performs a second preliminary operation when the approach degree satisfies a third condition and when it is determined that there is no space where the vehicle is movable after performing avoidance by the steering to any traveling path on a side of the target object, when it is determined that there is a misrecognized lane based on a lane width of a lane divided by two division lines among a plurality of recognized division lines, the traveling path on the side of the target object based on the lane other than the misrecognized lanes.

### TECHNICAL FIELD

The disclosure relates to a driving assistance device, a driving assistance method, and a program.

### BACKGROUND ART

In recent years, inventions of vehicle control devices that perform automatic deceleration control and automatic steering control have been disclosed (see, for example, Patent Document 1).

### CITATION LIST

### Patent Document

[Patent Document 1]
Japanese Unexamined Patent Application, First Publication No. 2020-50010

### SUMMARY OF INVENTION

### Technical Problem

A vehicle capable of performing automatic steering control in addition to automatic deceleration control has a high probability of being able to rapidly respond to sudden changes in the surrounding environment of the vehicle, and has a relatively high margin of control. On the other hand, when there is no avoidance space on the side of a target object, it becomes difficult to perform automatic steering control, and thus the margin of control is the same as that in a vehicle that only performs automatic deceleration control. In the related art, it may not be possible to perform operations according to such differences in environment.

The disclosure has been made in consideration of such circumstances, and an object of the disclosure is to provide a driving assistance device, a driving assistance method, and a program which are capable of appropriate preliminary operations according to the surrounding situation of a vehicle.

### Solution to Problem

A driving assistance device, a driving assistance method, and a program according to the disclosure adopt the following configuration.

(1) A driving assistance device according to one aspect of the disclosure includes a division line recognition part that recognizes division lines for dividing a traveling path around a vehicle, a braking control part that instructs a braking device of the vehicle to stop the vehicle when a degree of approach between the vehicle and a target object among objects in front of the vehicle satisfies a first condition with reference to an output of a detection device that detects the presence of the objects, and a steering avoidance control part that instructs a steering device of the vehicle to avoid coming into contact with the target object by steering, in which the braking control part includes a first preliminary operation control part that performs a first preliminary operation when the degree of approach satisfies a second condition, the braking control part further includes a second preliminary operation control part that performs a second preliminary operation when the degree of approach satisfies a third condition and when it is determined that there is no space where the vehicle is movable after performing avoidance by the steering to any traveling path on a side of the target object at a point in time when the third condition is satisfied, the first condition is a condition that is satisfied when the degree of approach is higher than that of the second condition, the second condition is a condition that is satisfied when the degree of approach is higher than that of the third condition, and when the second preliminary operation control part determines that there is a misrecognized lane based on a lane width of a lane divided by two division lines among a plurality of division lines recognized by the division line recognition part, the traveling path on the side of the target object is specified based on information on the lane other than the misrecognized lanes.

(2) In the aspect of (1) described above, when the lane width of the lane divided by the two division lines among the plurality of division lines recognized by the division line recognition part is less than a threshold value, one of the two division lines is deleted to recognize a lane, and the traveling path on the side of the target object is specified based on the recognized lane.

(3) In the aspect of (2) described above, the threshold value is a value that is set based on a lane width of a lane in which the vehicle travels.

(4) In any one of the aspects (1) to (3) described above, the second preliminary operation control part deletes a division line that is farther from the vehicle out of the two division lines when the lane width of the vehicle divided by the two division lines is less than the threshold value.

(5) In any one of the aspects (1) to (3) described above, the second preliminary operation control part deletes a division line with a lower degree of recognition which is recognized by the division line recognition part out of the two division lines when the lane width of the lane divided by the two division lines is less than the threshold value.

(6) In any one of the aspects (1) to (5) described above, the second preliminary operation control part deletes one division line based on line types of the two division lines when the lane width of the lane divided by the two division lines is less than the threshold value.

(7) In any one of the aspects (1) to (6) described above, the second preliminary operation is an operation that is started at an earlier timing than the first preliminary operation.

(8) In any one of the aspects (1) to (7) described above, at least one of the first preliminary operation and the second preliminary operation is an operation of instructing the braking device to output a braking force smaller than a braking force that the braking control part instructs the braking device to output.

(9) In any one of the aspects (1) to (8) described above, at least one of the first preliminary operation and the second preliminary operation is an operation of instructing an output device to perform a display, audio output, or vibration output for calling attention.

(10) A driving assistance method according to another aspect of the disclosure includes causing a driving assistance device to recognize division lines for dividing a traveling path around a vehicle, perform one or both of instructing a braking device of the vehicle to stop the vehicle when a degree of approach between the vehicle and a target object among objects in front of the vehicle satisfies a first condition with reference to an output of a detection device that detects the presence of the objects, and instructing a steering device of the vehicle to avoid coming into contact with the target object by steering, perform a first preliminary operation when the degree of approach between the target object and the vehicle satisfies a second condition, and perform a second preliminary operation when the degree of approach between the target object and the vehicle satisfies a third condition and when it is determined that there is no space where the vehicle is movable after performing avoidance by the steering to any traveling path on a side of the target object at a point in time when the third condition is satisfied, in which the first condition is a condition that is satisfied when the degree of approach is higher than that of the second condition, the second condition is a condition that is satisfied when the degree of approach is higher than that of the third condition, and when it is determined that there is a misrecognized lane based on a lane width of a lane divided by two division lines among a plurality of recognized division lines, the traveling path on the side of the target object is specified based on information on the lane other than the misrecognized lanes.

(11) A program according to still another aspect of the disclosure causes a computer to recognize division lines for dividing a traveling path around a vehicle, perform one or both of instructing a braking device of the vehicle to stop the vehicle when a degree of approach between the vehicle and a target object among objects in front of the vehicle satisfies a first condition with reference to an output of a detection device that detects the presence of the objects, and instructing a steering device of the vehicle to avoid coming into contact with the target object by steering, perform a first preliminary operation when the degree of approach between the target object and the vehicle satisfies a second condition, and perform a second preliminary operation when the degree of approach between the target object and the vehicle satisfies a third condition and when it is determined that there is no space where the vehicle is movable after performing avoidance by the steering to any traveling path on a side of the target object at a point in time when the third condition is satisfied, in which the first condition is a condition that is satisfied when the degree of approach is higher than that of the second condition, the second condition is a condition that is satisfied when the degree of approach is higher than that of the third condition, and when it is determined that there is a misrecognized lane based on a lane width of a lane divided by two division lines among a plurality of recognized division lines, the traveling path on the side of the target object is specified based on information on the lane other than the misrecognized lanes.

### Advantageous Effects of Invention

According to the aspects (1) to (11) described above, it is possible to perform appropriate preliminary operations according to the surrounding situation of a vehicle.

### BRIEF DESCRIPTION OF DRAWINGS

FIG. 1 is a configuration diagram of a vehicle equipped with a driving assistance device according to an embodiment.

FIG. 2 is a diagram showing an outline of functions of the driving assistance device.

FIG. 3 is a diagram showing an example of an operation scene of a steering avoidance control part.

FIG. 4 is a diagram showing a preliminary operation.

FIG. 5 is a flowchart showing an example of a flow of processing executed by the driving assistance device.

FIG. 6 is a diagram showing a division line recognition part 140.

FIG. 7 is a diagram showing an example of a division line recognized by the division line recognition part 140.

FIG. 8 is a diagram showing determination of lane misrecognition based on recognized division lines.

FIG. 9 is a flowchart showing an example of control processing based on recognition results of division lines around a vehicle M.

### DESCRIPTION OF EMBODIMENTS

Hereinafter, an embodiment of a driving assistance device, a driving assistance method, and a program of the disclosure will be described with reference to the drawings.

### Overall Configuration

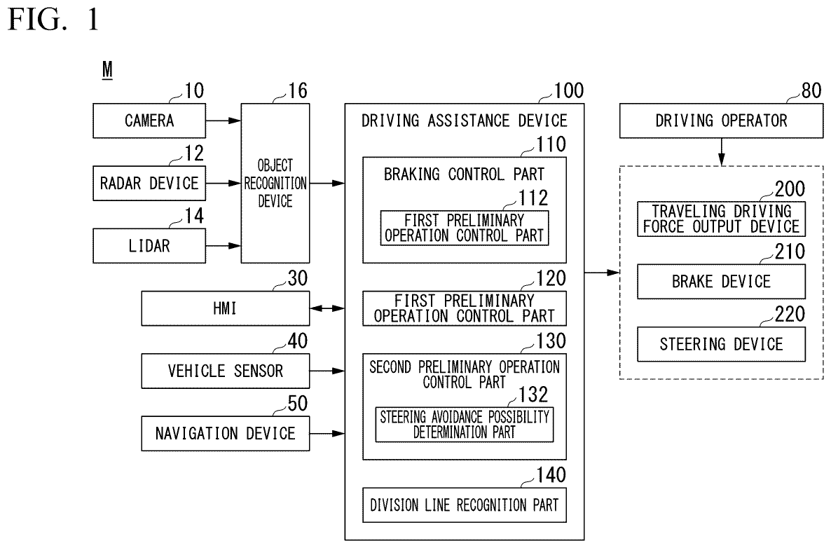

FIG. 1 is a configuration diagram of a vehicle M in which a driving assistance device 100 according to an embodiment is mounted. The vehicle M is, for example, a two-wheeled, three-wheeled, or four-wheeled vehicle, and its driving source is an internal combustion engine such as a diesel engine or a gasoline engine, an electric motor, or a combination thereof. The electric motor operates using electric power generated by a generator connected to an internal combustion engine, or electric power discharged from a secondary battery or a fuel cell.

The vehicle M is equipped with, for example, a camera 10, a radar device 12, a Light Detection and Ranging (LIDAR) 14, an object recognition device 16, a Human Machine Interface (HMI) 30, a vehicle sensor 40, a driving operator 80, a driving assistance device 100, a traveling driving force output device 200, a brake device 210, and a steering device 220. These devices and equipment are connected to each other via multiplex communication lines such as controller area network (CAN) communication lines, serial communication lines, a wireless communication network, or the like. The configuration shown in FIG. 1 is merely an example, and a part of the configuration may be omitted, or another configuration may be added. The HMI 30 is an example of an “output device.” The brake device 210 is an example of a “brake device.” The steering device 220 is an example of a “steering device.”

The camera 10 is, for example, a digital camera that uses a solid-state imaging device such as a charge coupled device (CCD) or a complementary metal oxide semiconductor (CMOS). The camera 10 is attached to any position on a vehicle (hereinafter referred to as a vehicle M) in which the vehicle system 1 is mounted. When the front of the vehicle is imaged, the camera 10 is attached to an upper part of a front windshield, the rear surface of a room mirror, or the like. For example, the camera 10 periodically and repeatedly images the surroundings of the vehicle M. The camera 10 may be a stereo camera.

The radar device 12 emits radio waves such as millimeter waves around the vehicle M, and detects radio waves (reflected waves) reflected by an object to detect at least the position (distance and direction) of the object. The radar device 12 is attached to any position on the vehicle M. The radar device 12 may detect the position and velocity of an object using a frequency modulated continuous wave (FM-CW) method.

The LIDAR 14 irradiates the surroundings of the vehicle M with light (or electromagnetic waves with a wavelength close to light) and measures scattered light. The LIDAR 14 detects a distance to a target based on a period of time from light emission to light reception. The emitted light is, for example, pulsed laser light. The LIDAR 14 is attached to any position on the vehicle M.

The object recognition device 16 performs sensor fusion processing on detection results obtained by some or all of the camera 10, the radar device 12, and the LIDAR 14 to recognize the position, type, speed, and the like of the object. The object recognition device 16 outputs recognition results to the driving assistance device 100. The object recognition device 16 may output detection results of the camera 10, the radar device 12, and the LIDAR 14 as they are to the driving assistance device 100. The object recognition device 16 may be omitted from the vehicle system 1. Some or all of the camera 10, the radar device 12, the LIDAR 14, and the object recognition device 16 are examples of “detection devices.”

The HMI 30 presents various information to an occupant of the vehicle M, and also receives input operations from the occupant. The HMI 30 includes various display devices, a speaker, a buzzer, a vibration generation device (vibrator), a touch panel, a switch, keys, and the like.

The vehicle sensor 40 includes a vehicle speed sensor that detects the speed of the vehicle M, an acceleration sensor that detects an acceleration, a yaw rate sensor that detects an angular velocity around a vertical axis, an azimuth sensor that detects the direction of the vehicle M, and the like.

The navigation device 50 includes, for example, a global navigation satellite system (GNSS) receiver, a guidance control part, a storage part that stores map information, and the like. The GNSS receiver specifies the position of the vehicle M based on signals received from GNSS satellites. The position of the vehicle M may be specified or complemented by an inertial navigation system (INS) using an output of the vehicle sensor 40. For example, the guidance control part determines a route from the position (or any input position) of the vehicle M specified by the GNSS receiver to a destination input by the occupant with reference to the map information, and causes the HMI 30 to output guidance information so that the vehicle M travels along the route. The map information is, for example, information in which a road shape is expressed by links indicating roads and nodes connected by the links. The map information may include the number of lanes and curvatures of roads, Point of Interest (POI) information, information on road division lines (for example, shape, line type, color), and the like. The navigation device 50 may transmit the current position and destination of the vehicle M to a navigation server via a communication device, and may acquire a route from the navigation server.

The driving operator 80 includes, for example, an accelerator pedal, a brake pedal, a steering wheel, a shift lever, and other operators. A sensor that detects the amount of operation or whether an operation has been performed is attached to the driving operator 80, and a detection result thereof is output to some or all of the traveling driving force output device 200, the brake device 210, and the steering device 220.

The traveling driving force output device 200 outputs a traveling driving force (torque) for driving the vehicle to drive wheels. The traveling driving force output device 200 includes, for example, a combination of an internal combustion engine, an electric motor, a transmission, and the like and an electronic control part (ECU) that controls them. The ECU controls the above-described configuration in accordance with information input from the driving assistance device 100 or information input from the driving operator 80.

The brake device 210 includes, for example, a brake caliper, a cylinder that transmits hydraulic pressure to the brake caliper, an electric motor that generates hydraulic pressure in the cylinder, and an ECU. The ECU controls the electric motor in accordance with information input from the driving assistance device 100 or information input from the driving operator 80 so that a brake torque corresponding to a braking operation is output to each wheel. The brake device 210 may include, as a backup mechanism, a mechanism that transmits hydraulic pressure generated by operating the brake pedal included in the driving operator 80 to the cylinder via a master cylinder. The brake device 210 is not limited to the configuration described above, and may be an electronically controlled hydraulic brake device that controls an actuator in accordance with information input from the driving assistance device 100 and transmits the hydraulic pressure of the master cylinder to the cylinder.

The steering device 220 includes, for example, a steering ECU and an electric motor. For example, the electric motor applies a force to a rack and pinion mechanism to change the direction of steered wheels. The steering ECU drives the electric motor in accordance with information input from the driving assistance device 100 or information input from the driving operator 80 to change the direction of the steered wheels.

### [Driving Assistance Device]

The driving assistance device 100 includes, for example, a braking control part 110, a steering avoidance control part 120, a second preliminary operation control part 130, and a division line recognition part 140. The braking control part 110 includes a first preliminary operation control part 112, and the second preliminary operation control part 130 includes a steering avoidance possibility determination part 132. These functional parts are implemented by, for example, a hardware processor such as a Central Processing Unit (CPU) executing a program (software). In addition, some or all of these components may be implemented by hardware (including circuitry) such as a large scale integration (LSI), an application specific integrated circuit (ASIC), a field-programmable circuit (FPGA), or a graphics processing unit (GPU), or may be implemented by software and hardware in cooperation. The program may be stored in advance in a storage device (a storage device including a non-transitory storage medium) such as a HDD or a flash memory of the driving assistance device 100, or may be stored in a detachable storage medium such as a DVD or a CD-ROM and installed in the HDD or the flash memory of the driving assistance device 100 by attaching the storage medium (non-transitory storage medium) to a drive device.

Instructions given from the driving assistance device 100 to the traveling driving force output device 200, the brake device 210, and the steering device 220 are set inside the traveling driving force output device 200, the brake device 210, and the steering device 220 so that the instructions are executed in preference to the detection results received from the driving operator 80. Regarding braking, when a braking force based on the amount of operation of the brake pedal is greater than the instruction received from the driving assistance device 100, the instruction may be set so that the braking force is preferentially executed. Further, as a mechanism for preferentially executing instructions received from the driving assistance device 100, communication priority in an in-vehicle local area network (LAN) may be used.

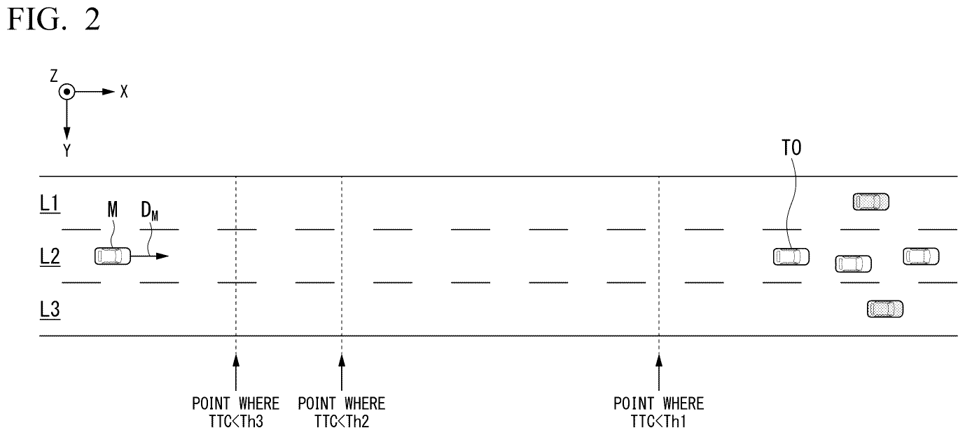

FIG. 2 is a diagram showing an outline of functions of the driving assistance device 100. Hereinafter, each part of the driving assistance device 100 will be described with reference to FIGS. 1 and 2. In FIG. 2, the vehicle M is traveling on a three-lane road extending in an X-axis direction in the drawing, and is located in a lane L2 in the middle of the load. DM is a traveling direction of the vehicle M. A Y-axis direction in the drawing is a road width (lane width) direction. A Z-axis direction in the drawing is a vertical direction with respect to the vehicle M or the road surface (horizontal surface). Hereinafter, description may be made using an XYZ coordinate system as necessary.

The braking control part 110 instructs at least the brake device 210 out of the brake device 210 and the traveling driving force output device 200 to decelerate and stop the vehicle M when the degree of approach between a target object TO and the vehicle M satisfies a first condition, with reference to an output of the detection device (described above) that detects the presence of an object in front of the vehicle M. The target object TO is an object that is on the same traveling path as the vehicle M and on a side in the traveling direction of the vehicle M, and is an object that the vehicle M should avoid coming into contact with, excluding objects that can be climbed over such as manholes. The braking control part 110 extracts such an object and sets it as the target object TO. In the example of FIG. 2, a vehicle (a vehicle closest to the vehicle M) at the tail of a plurality of vehicles in front of the vehicle M and traveling in the same lane L2 as the vehicle M is set as the target object TO. The traveling path is, for example, a lane. Lanes are divided by, for example, division lines (for example, road division lines) recognized by the division line recognition part 140. Further, the lanes may be virtual lanes that are virtually set by the vehicle M on a road surface where there are no road division lines. The same applies to the following description.

“The degree of approach” is represented by various index values indicating the degree of approach between objects. For example, “the degree of approach” is Time To Collision (TTC), which is an index value obtained by dividing a distance by a relative speed (a direction in which they approach each other is set to be positive). When the relative speed is negative (in a direction in which they are away from each other), TTC is temporarily set to infinity. TTC is an index value indicating that the smaller the value, the higher “the degree of approach.” Satisfying the “first condition” means that, for example, TTC is less than a first threshold value Th1. The first threshold value Th1 is, for example, a value of 1 and several tenths of a [sec]. Instead of TTC, index values having similar properties, such as a vehicle head time and a distance, or other index values may be used as “the degree of approach.” Further, TTC adjusted by applying an acceleration and a jerk may be used as “the degree of approach”. In the following description, description will be given on the assumption that “the degree of approach” is TTC.

When the TTC is less than the first threshold value Th1, the braking control part 110 instructs the brake device 210 and/or the traveling driving force output device 200 to output a braking force for decelerating the vehicle M at a first deceleration B1, for example. The first deceleration B1 is a deceleration of, for example, several tenths of a [G] (close to 1). Thereby, the braking control part 110 rapidly decelerates and stops the vehicle M to avoid a contact with the target object TO. The brake device 210 and the ECU of the traveling driving force output device 200 have a function of obtaining a brake output, a regeneration control amount, an engine braking amount, and the like from the instructed deceleration, and the ECU determines each control amount based on the instructed deceleration and the speed of the vehicle M. This is a known technique, and detailed description thereof will be omitted.

The operation of the first preliminary operation control part 112 will be described later, and the steering avoidance control part 120 will be described first.

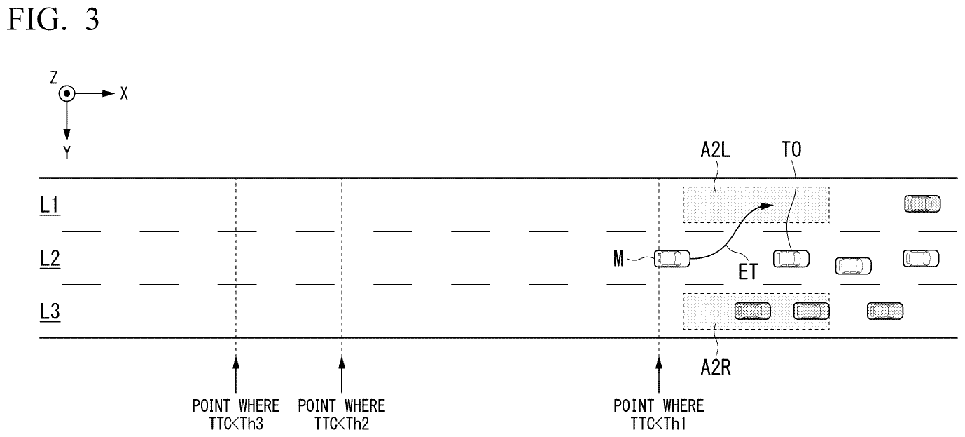

FIG. 3 is a diagram showing an example of an operation scene of the steering avoidance control part 120. When it is determined that it is difficult for the braking control part 110 to stop the vehicle M in front of the target object TO, the steering avoidance control part 120 determines whether there is a space where the vehicle M can move on a traveling path on the side of the target object TO (for example, lanes L1 and L3). When it is determined that there is a space, the steering avoidance control part 120 generates an avoidance trajectory ET and instructs the steering device 220 to cause the vehicle M to move along the avoidance trajectory ET (steering avoidance). For example, the steering avoidance control part 120 determines whether an object is present in a side area extending from slightly in front of the target object TO to the rear thereof on both sides of the target object TO such as areas A2L and A2R shown in FIG. 3. When it is determined that there is no such a space, the steering avoidance control part 120 determines that there is a space where the vehicle M can move on the traveling path on the side of the target object TO. Whether it is difficult for the braking control part 110 to stop the vehicle M in front of the target object TO may be determined by the braking control part 110 or may be determined by the steering avoidance control part 120. The steering avoidance control part 120 also recognizes the boundaries of the traveling path by recognizing division lines for dividing lanes, such as white lines and road shoulders in camera images. In the first place, when there is neither the area A2L nor the area A2R where the vehicle M can travel, for example, when there is neither the lane L1 and the lane L3, it may be determined that there is an object in the area.

Steering avoidance is performed in a scene where a sudden change in the surrounding environment of the vehicle occurs, such as when the target object TO decelerates unexpectedly, or when an object other than the recognized target object TO gets in between the vehicle M and the target object TO and is recognized as a new target object TO. In such a scene, there is a possibility that it may not be possible to cope with the scene with a deceleration calculated in advance so that the vehicle stops in front of the target object TO, but it is possible to increase the probability that it is possible to cope with sudden changes in the surrounding environment of the vehicle M by having a steering avoidance function.

### [Preliminary Operation]

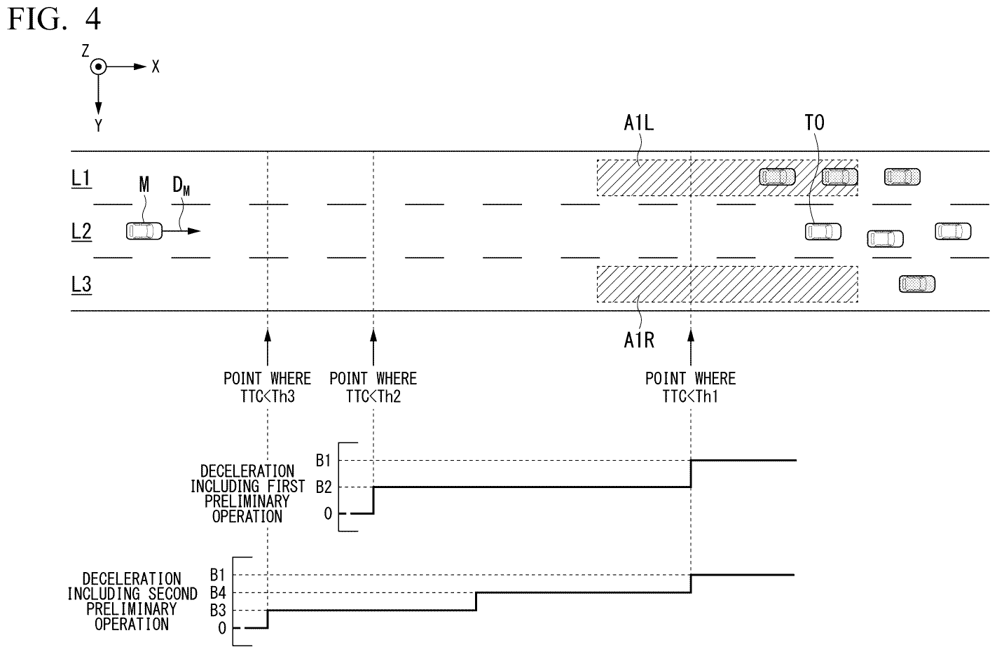

Hereinafter, processing of the first preliminary operation control part 112 and the second preliminary operation control part 130 will be described. FIG. 4 is a diagram showing a preliminary operation.

The first preliminary operation control part 112 performs a first preliminary operation for transmitting the presence of the target object TO to a driver of the vehicle M when the degree of approach between the target object TO and the vehicle M satisfies a second condition (for example, when the TTC is less than a second threshold value Th2). The first preliminary operation is, for example, an operation of instructing the brake device 210 and/or the traveling driving force output device 200 to output a braking force for decelerating the vehicle M at a second deceleration B2 from when the TTC becomes less than the second threshold value Th2 to when the TTC becomes less than the first threshold value Th1. The second deceleration B2 is a deceleration that is smaller (closer to zero) than the first deceleration B1. The second threshold value Th2 is a value that is larger than the first threshold value Th1. Thus, the first condition is a condition that is satisfied when the degree of approach is higher than that of the second condition.

The second preliminary operation control part 130 performs a second preliminary operation for transmitting the presence of the target object TO to the driver of the vehicle M when the degree of approach between the target object TO and the vehicle M satisfies a third condition (for example, the TTC is less than a third threshold value Th3), and when it is determined that there is no space where the vehicle M can move after performing avoidance by steering to any traveling path on the side of the target object TO at a point in time when the third condition is satisfied. Determination regarding the space where the vehicle M can move is performed by the steering avoidance possibility determination part 132. The third threshold value Th3 is a value that is larger than the second threshold value Th2. Thus, the second condition is a condition that is satisfied when the degree of approach is higher than that of the third condition.

For example, at a point in time when the TTC becomes less than the third threshold value Th3, the steering avoidance possibility determination part 132 determines whether there is an object in a side region extending from slightly in front of the target object TO to the rear thereof on both sides of the target object TO such as areas A1L and A1R shown in FIG. 4. When it is determined that there is not such an object, the steering avoidance possibility determination part 132 determines that there is a space where the vehicle M can move on the traveling path on the side of the target object TO. The areas A1L and A1R are respectively set to be larger than the areas A2L and A2R in consideration of, for example, future uncertain factors. Similarly to the steering avoidance control part 120, the steering avoidance possibility determination part 132 also recognizes the boundaries of the traveling path by recognizing division lines such as white lines and road shoulders in camera images. In the first place, when there is neither of the areas A1L and A1R where the vehicle M can travel, for example, when there is neither the lane L1 nor the lane L3, it is determined that there is an object in the area. In the example of FIG. 4, there is no object in the area A1R, the steering avoidance possibility determination part 132 determines that there is a space where the vehicle M can move on the traveling path on the side of the target object TO.

The second preliminary operation is, for example, an operation of first instructing the brake device 210 and/or the traveling driving force output device 200 to output a braking force for decelerating the vehicle M at a third deceleration B3 and then instructing the brake device 210 and/or the traveling driving force output device 200 to output a braking force for decelerating the vehicle M at a fourth deceleration B4 from when the TTC becomes less than the third threshold value Th3 to when the TTC becomes less than the first threshold value Th1. For example, the third deceleration B3 is a deceleration that is smaller than the second deceleration B2 (close to zero), and the fourth deceleration B4 is a deceleration that is larger than or approximately the same as the second deceleration and smaller that the first deceleration B1. A timing at which the third deceleration B3 switches to the fourth deceleration B4 may be set arbitrarily.

In this manner, the second preliminary operation is started at an earlier timing than the first preliminary operation, and is performed in multiple stages. As described above, in a situation where steering avoidance can be performed, a probability that the vehicle can rapidly respond to sudden changes in the surrounding environment of the vehicle increases, and the margin of control is relatively high. On the other hand, when there is no avoidance space on the side of the target object, it is difficult to execute a steering avoidance function even when the vehicle is equipped with the function, and thus the margin of control is no different from that of a vehicle that can perform only automatic stopping. That is, in a situation where steering avoidance is difficult, it is preferable to alert the driver of the vehicle M more rapidly and effectively than in a situation where steering avoidance can be performed. According to the present embodiment, the second preliminary operation is started at an earlier timing than the first preliminary operation and is performed in multiple stages, thereby making it possible to perform an appropriate preliminary operation according to the surrounding situation of the target object.

The division line recognition part 140 recognizes division lines for dividing traveling paths in the vicinity of the vehicle M based on detection results of the detection device. The vicinity of the vehicle M is a range within a predetermined distance from the vehicle M, and includes at least the sides of the target object. Details of the division line recognition part 140 will be described later.

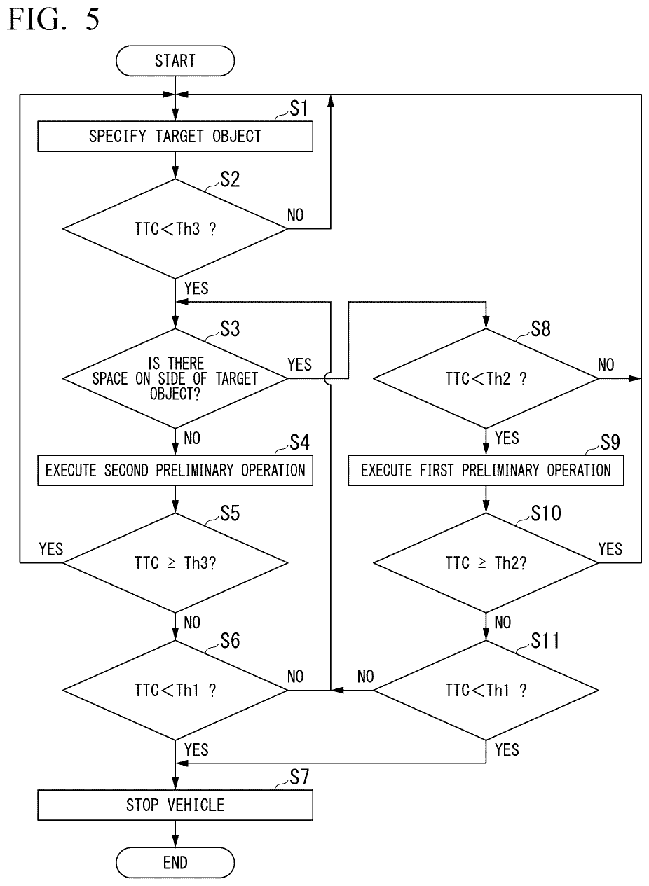

FIG. 5 is a flowchart showing an example of a flow of processing executed by the driving assistance device 100.

First, the braking control part 110 specifies the target object TO (step S1). Next, the second preliminary operation control part 130 determines whether the TTC between the vehicle M and the target object TO is less than the third threshold value Th3 (step S2). When the TTC between the vehicle M and the target object TO is equal to or greater than the third threshold value Th3, the processing returns to step S1.

When it is determined that the TTC between the vehicle M and the target object TO is less than the third threshold value Th3, the steering avoidance possibility determination part 132 of the second preliminary operation control part 130 determines whether there is a space where the vehicle M can move on the traveling path on the side of the target object TO (step S3).

When it is determined that there is no space where the vehicle M can move on the traveling path on the side of the target object TO, the second preliminary operation control part 130 executes the second preliminary operation (step S4). Next, the second preliminary operation control part 130 determines whether the TTC between the vehicle M and the target object TO has increased and become equal to or greater than the third threshold value Th3 (step S5). When it is determined that the TTC between the vehicle M and the target object TO has increased and become equal to or greater than the third threshold value Th3, the processing returns to step S1.

When it is not determined that the TTC between the vehicle M and the target object TO has increased and become equal to or greater than the third threshold value Th3, the braking control part 110 determines whether the TTC between the vehicle M and the target object TO is less than the first threshold value Th1 (step S6). When it is determined that the TTC between the vehicle M and the target object TO is equal to or greater than the first threshold value Th1, the processing returns to step S3. When an affirmative determination is obtained in step S3, the second preliminary operation is stopped, and the process of step S8 and the subsequent processes are executed. When it is determined that the TTC between the vehicle M and the target object TO is less than the first threshold value Th1, the braking control part 110 causes the brake device 210 and/or the traveling driving force output device 200 to output a braking force for decelerating the vehicle M at the first deceleration B1 to decelerate and stop the vehicle M (step S7). At this time, as described above, steering avoidance may be performed instead of (or in addition to) decelerating and stopping the vehicle M.

When an affirmative determination is obtained in step S3, that is, when the TTC between the vehicle M and the target object TO is less than the third threshold value Th3, and there is a space where the vehicle M can move on the traveling path on the side of the target object TO, the first preliminary operation control part 112 of the braking control part 110 determines whether the TTC between the vehicle M and the target object TO is less than the second threshold value Th2 (step S8). When it is determined that the TTC between the vehicle M and the target object TO is equal to or greater than the second threshold value Th2, the processing returns to step S1.

When it is determined that the TTC between the vehicle M and the target object TO is less than the second threshold value Th2, the first preliminary operation control part 112 executes the first preliminary operation (step S9). Next, the first preliminary operation control part 112 determines whether the TTC between the vehicle M and the target object TO has increased and become equal to or greater than the second threshold value Th2 (step S10). When it is determined that the TTC between the vehicle M and the target object TO has increased and become equal to or greater than the second threshold value Th2, the processing returns to step S1.

When it is not determined that the TTC between the vehicle M and the target object TO has increased and become equal to or higher than the second threshold value Th2, the braking control part 110 determines whether the TTC between the vehicle M and the target object TO is less than the first threshold value Th1 (step S11). When it is determined that the TTC between the vehicle M and the target object TO is equal to or greater than the first threshold value Th1, the processing returns to step S3. When a negative determination is obtained in step S3, the first preliminary operation is stopped, and the process of step S4 and the subsequent processes are executed. When it is determined that the TTC between the vehicle M and the target object TO is less than the first threshold value Th1, the braking control part 110 causes the brake device 210 and/or the traveling driving force output device 200 to output the first deceleration B1 to decelerate and stop the vehicle M (step S7).

### [Control Based on Recognition Results of Division Lines Around Vehicle M]

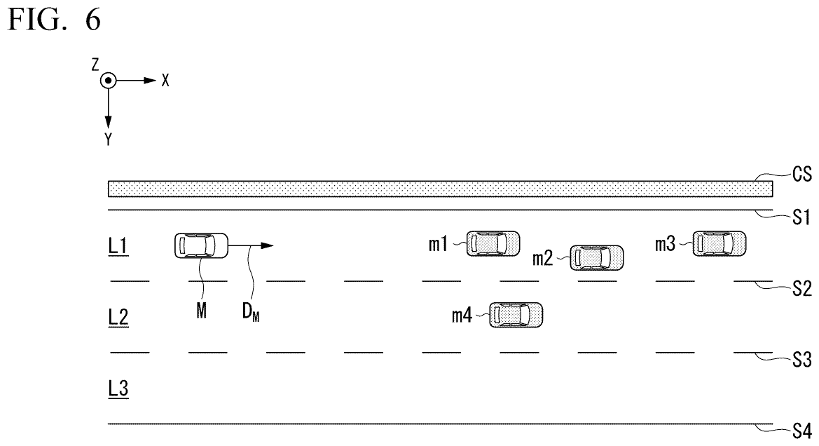

Hereinafter, control based on recognition results of the division lines around the vehicle M which are obtained by the division line recognition part 140 will be described. FIG. 6 is a diagram showing the division line recognition part 140. In the example of FIG. 6, it is assumed that the vehicle M is traveling in a traveling direction DM in the lane L1 of a road with three lanes (lanes L1 to L3) extending in the X-axis direction in the drawing. The lane L1 is divided by two road division lines S1 and S2, the lane L2 is divided by two road division lines S2 and S3, and lane L3 is divided by two road division lines S3 and S4. Further, in the example of FIG. 6, it is assumed that there are other vehicles m1 to m3 traveling in the lane L1 and a different vehicle m4 traveling in the lane L2 in front of the vehicle M. The other vehicles m1 to m4 correspond to objects that are present in front of the vehicle M which are detected by the detection device, and the different vehicle m1 corresponds to the target object TO described above. Further, in the example of FIG. 6, the curbstone CS is installed in the extension direction of the lane L1 at a distance from the road division line S1 when viewed from the vehicle M. The curbstone CS is an example of a road structure. The road structures may include, for example, guardrails, fences, and the like.

Under the situation shown in FIG. 6, the division line recognition part 140 extracts and arranges edge points from an image captured by the camera 10, and recognizes the edge points as the outline of the division lines. Line types (for example, a solid line, a broken line), colors (for example, white, yellow), and the like of the division lines may be recognized from the outline. The division line recognition part 140 may recognize the division lines based on information on reflected light from a road detected by the LIDAR 14 (white lines have a high reflectance, and thus the area can be recognized). Further, the division line recognition part 140 recognizes the position of each recognized division line (for example, a relative position from the vehicle M). Further, the division line recognition part 140 may acquire the degree of recognition for each recognized division line. The degree of recognition is an index value indicating the probability (likelihood) that a line is a division line, and the higher the degree of recognition, the higher the possibility that a line is a road division line. In addition, the degree of recognition is derived based on, for example, the degree of matching between division line information (for example, a shape, a line type, a color, a length, and a thickness) recognized from an image captured by the camera 10 and reference division line information. In addition, instead of (or in addition to) the degree of matching described above, the degree of recognition may be derived based on the degree of matching between the division line information recognized from an image captured by the camera 10 and division line information recognized by the LIDAR 14 and the degree of matching between the division line information recognized from an image captured by the camera 10 and information on the road division lines included in the map information of the navigation device 50.

Here, in the surrounding situation of the vehicle M as shown in FIG. 6, the division line recognition part 140 may misrecognize the edge portion of the curbstone CS as a division line, or may misrecognize one road division line as two or more division lines due to the influence of the thickness, scratches, dirt, or the like of the road division line.

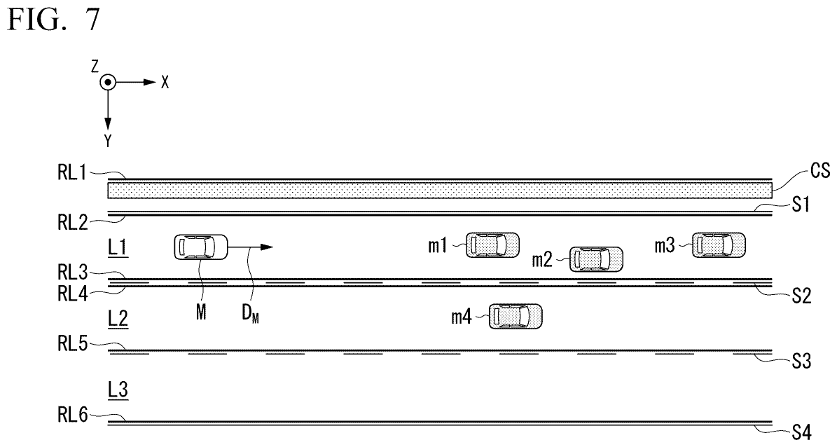

FIG. 7 is a diagram showing an example of division lines recognized by the division line recognition part 140. FIG. 7 shows an example of recognition results obtained by the division line recognition part 140 in the surrounding situation of the vehicle M shown in FIG. 6. In this case, the division line recognition part 140 recognizes division lines RL1 to RL6 as division lines, as shown in FIG. 7. In other words, the division line recognition part 140 may misrecognize a part of the curbstone CS as the division line RL1 due to the influence of the shape of the actual curbstone CS, sunlight, shadow, or the like or may misrecognize that there are two or more division lines RL3 and RL4 from one road division line S2 due to the influence of scratches, dirt, or the like on the road division line S2 actually drawn on the road. As a result of this misrecognition, for example, there is a possibility that it may be misrecognized that there is a lane divided by two division lines RL1 and RL2 on the left side of the different vehicle m1 when viewed from the vehicle M, or it may be misrecognized and determined that there is a lane divided by two division lines RL3 and RL4 on the right side of the different vehicle m1 when viewed from the vehicle M. Thus, when the steering avoidance possibility determination part 132 determines whether avoidance can be performed, it may misrecognized and determined that there is a traveling path on the left side of the different vehicle m1, or it may be misrecognized that there is no other vehicles (there is a vehicle in the right adjacent lane) even though there is actually the different vehicle m4 in the lane L2 (the right adjacent lane of the traveling lane L1 of the host vehicle M) on the right side of the different vehicle m1. The above-described misrecognition also has a large effect on the control performed by the steering avoidance control part 120.

Consequently, the steering avoidance possibility determination part 132 determines whether there is a lane that is misrecognized, based on the lane width (in other words, a distance between two division lines that are parallel to each other) of a lane (traveling path) divided by two division lines among a plurality of division lines recognized by the division line recognition part 140. When the steering avoidance possibility determination part 132 determines that there is a lane that is misrecognized, the steering avoidance possibility determination part 132 specifies a traveling path on the side of the different vehicle m1 (target object) based on information (for example, a position and a range) on lanes other than the lane that is misrecognized. When the steering avoidance possibility determination part 132 determines that there is no lane that is misrecognized, the steering avoidance possibility determination part 132 specifies a traveling path on the sides of other vehicles based on information on the recognized lane.

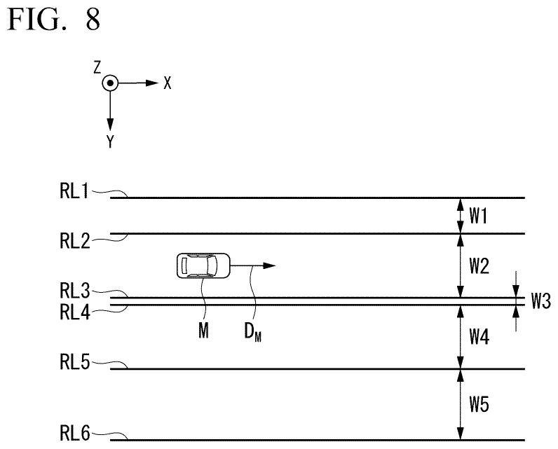

FIG. 8 is a diagram showing determination of lane misrecognition based on recognized division lines. In the example of FIG. 8, the vehicle M and the division lines RL1 to RL6 shown in FIG. 7 are shown. The steering avoidance possibility determination part 132 acquires the lane width of a lane (the length in the Y-axis direction (road width direction, lateral direction) which is divide by two division lines (adjacent two division lines) which are closest and parallel to each other among the division lines RL1 to RL6. In the example of FIG. 8, the steering avoidance possibility determination part 132 recognizes a lane width W1 of a lane divided by the division lines RL1 and RL2, a lane width W2 of a lane divided by the division lines RL2 and RL3, a lane width W3 of a lane divided by the division lines RL3 and RL4, a lane width W4 of a lane divided by the division lines RL4 and RL5, and a lane width W6 of a lane divided by the division lines RL5 and RL6. Then, the steering avoidance possibility determination part 132 determines whether each of the lane widths W1 to W6 is less than a threshold value.

Here, the threshold value is, for example, a value that is set based on the lane width of a lane in which the vehicle M is traveling (the lane width W2 in the drawing), and is, for example, a value that is approximately half of the lane width W2. Since division lines for dividing the lane in which the vehicle travels are right and left division lines that are closest to the vehicle M, the accuracy of recognition is assumed to be higher than that of other division lines. Thus, it is possible to perform determination with higher accuracy based on the lane width W2 of the lane in which the vehicle M travels. Further, the value that is approximately half of the lane width is a value with which it is predicted that the vehicle M can travel in the extension direction of the lane. The threshold value may be set to a predetermined fixed value (for example, a value that is approximately half of the minimum lane width under road regulations), and may be set to a value based on the lane width of the vehicle M (also including a predetermined margin width that allows the vehicle to move).

When the lane width of the lane is less than the threshold value, the steering avoidance possibility determination part 132 deletes one of the two division lines for dividing the lane corresponding to the lane width, recognizes the lane, specifies a traveling path on the side of the different vehicle m1 based on the recognized lane, and determines whether steering avoidance can be performed. In the example of FIG. 8, it is assumed that the widths W1 and W3 are less than the threshold value. For this reason, the steering avoidance possibility determination part 132 deletes one of the division lines RL1 and RL2, and deletes one of the division lines RL3 and RL4. For example, since it is assumed that the accuracy of recognition is higher for a division line that is closer to the vehicle M, the steering avoidance possibility determination part 132 deletes the division line that is farther from the vehicle M out of the two division lines when viewed from the vehicle M. In the example of FIG. 8, the division line RL1 is deleted out of the division lines RL1 and RL2, and the division line RL4 is deleted out of the division lines RL3 or RL4.

Further, the steering avoidance possibility determination part 132 may delete the division line with a lower degree of recognition among the two division lines, which is recognized by the division line recognition part 140, out of the two division lines when the lane width of the lane is less than the threshold value. For example, when the degree of recognition of the division line RL4 is lower than the degree of recognition of the division line RL3, the division line recognition part 140 deletes the division line RL4. Thereby, it is possible to more accurately acquire the position and range of the lane based on the division lines that have a high degree of recognition.

Further, when the lane width of the lane is less than the threshold value, the steering avoidance possibility determination part 132 may delete one division line based on the line types of the two division lines. In this case, there is a higher possibility that a broken line will be misrecognized than a solid line, and thus, when the line types of the two division lines are a solid line and a broken line, the steering avoidance possibility determination part 132 deletes the broken line. Thereby, for example, when a deceleration broken line is drawn on a road, the deceleration broken line can be deleted. The deceleration broken line is a road surface marking that makes a lane width appear narrow to a driver of a vehicle, for example, in a road unit where there are many collisions between vehicles, and it can be expected that the vehicle is decelerated during manual driving by making the lane width appear narrow to the driver by using the deceleration broken line. The deceleration broken line is provided, for example, along a road division line.

Through the above-described processing, the steering avoidance possibility determination part 132 can correctly recognize lanes (recognize lanes other than those misrecognized) based on the remaining division lines RL2, RL3, RL5, and RL6. Thus, for example, in the surrounding situation of the vehicle M shown in FIGS. 6 and 7, the steering avoidance possibility determination part 132 can correctly recognize that the different vehicle m4 is present in the adjacent lane on the right side of the different vehicle m1 without recognizing a road shoulder area (a region divided by the division lines RL1 and RL2) on the left side of the different vehicle m1 as an adjacent lane. Then, the steering avoidance possibility determination part 132 can more accurately determine whether there is a space where the vehicle M can move on a traveling path on the side of the different vehicle m1 by using the recognized vehicles.

When the steering avoidance possibility determination part 132 determines whether there is a space on the side of the different vehicle m1 for a lane adjacent to the lane in which the different vehicle m1 travels, the lane (that is, an adjacent lane when viewed from the vehicle M or the different vehicle m1) which is divided by two division lines RL5 and RL6 may be excluded from the above-described misrecognition determination processing.

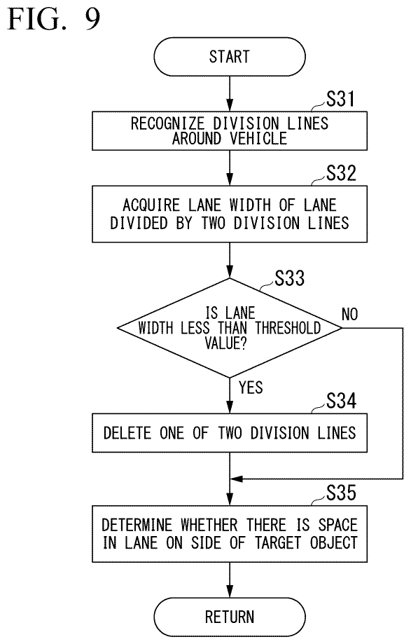

FIG. 9 is a flowchart showing an example of control processing based on recognition results of division lines around the vehicle M. The processing in FIG. 9 is, for example, processing corresponding to step S3 in the processing shown in FIG. 5 described above. In the example of FIG. 9, the division line recognition part 140 recognizes division lines around the vehicle M (step S31). Next, the steering avoidance possibility determination part 132 acquires the lane width of a lane divided by two division lines among the plurality of recognized division lines (step S32), and determines whether the lane width is less than a threshold value (step S33). When it is determined that the lane width is less than the threshold value, the steering avoidance possibility determination part 132 deletes one of the two division lines (step S34). After the process of step S34, the steering avoidance possibility determination part 132 may repeatedly execute the processes of steps S32 to S34 by using the remaining division lines that have not been deleted until the lane widths of all vehicles become equal to or greater than the threshold value.

When it is determined that the lane width is not less than the threshold value after the process of step S34 or in the process of step S33, the steering avoidance possibility determination part 132 determines whether there is a space where the vehicle M performs steering avoidance or the like in a lane (for example, an adjacent lane) on the side of a target object based on the recognized lanes (lanes other than a misrecognized lane) (step S35). Thereby, the processing of this flowchart ends.

### Modification Example

In the embodiment described above, the steering avoidance possibility determination part 132 compares the number of division lines recognized by the division line recognition part 140 with the number of lanes included in map information of the navigation device 50. When they do not match each other, the steering avoidance possibility determination part 132 may determine that steering avoidance of the vehicle M cannot be performed. Further, in the embodiment described above, the processing related to lane misrecognition determination in the steering avoidance possibility determination part 132 described above may be performed by the steering avoidance control part 120 or may be performed by the division line recognition part 140.

In the above embodiment, in either the first preliminary operation or the second preliminary operation, the HMI 30 may perform a display, audio output, vibration output, or the like for calling attention, instead of outputting a braking force. In this case, examples in which the second preliminary operation is performed in multiple stages include differentiating the degree of focusing (contrast, brightness, color, or the like) of a first display screen from those of second and subsequent display screens, differentiating the content or volume of a first audio output from those of second and subsequent audio outputs, making second and subsequent vibration outputs larger than a first vibration output, and the like, instead of outputting a braking force in stages while changing the degree of deceleration as described above.

In the above embodiment, when a branch road to a destination that is set in the navigation device 50 is on either the left or right side of a lane in which the vehicle M is traveling, a lane change may be forcibly performed in the middle of a preliminary operation. In this manner, as a result, the vehicle M can be moved in a direction in which the vehicle M approaches the destination, and the vehicle M can be guided to a state where a target object is not near the vehicle M.

According to the embodiment described above, the driving assistance device 100 includes the division line recognition part 140 that recognizes division lines for dividing a traveling path around the vehicle M, a braking control part 110 that instructs the braking device of the vehicle to stop the vehicle when the degree of approach between a target objects among objects and the vehicle satisfies a first condition, with reference to an output of a detection device that detects the presence of objects in front of the vehicle M, and the steering avoidance control part 120 that instructs the steering device of the vehicle M to avoid coming into contact with the target object by steering. The braking control part 110 includes the first preliminary operation control part 112 that performs a first preliminary operation when the degree of approach satisfies a second condition, and further includes the second preliminary operation control part 130 that performs a second preliminary operation when it is determined that the degree of approach satisfies a third condition and when it is determined that there is no space where the vehicle M can move after performing avoidance by steering to any traveling path on the side of the target object at a point in time when the third condition is satisfied. The first condition is a condition that is satisfied when the degree of approach is higher than that of the second condition, and the second condition is a condition that is satisfied when the degree of approach is higher than that of the third condition. When it is determined that there is a misrecognized lane based on the lane width of a lane divided by two division lines among a plurality of division lines recognized by the division line recognition part 140, the second preliminary operation control part 130 can perform an appropriate preliminary operation according to the surrounding situation of the vehicle M by specifying a traveling path on the side of the target object based on information on lanes other than the misrecognized lane.

Specifically, in accordance with the embodiment, for example, when the second preliminary operation is executed, or the like, recognition results of the lanes around the vehicle are checked. When there is a discrepancy in check results (when it is determined that a lane or a division line is misrecognized), it is possible to determine whether steering avoidance can be performed and to suppress erroneous braking by performing control based on lanes other than the misrecognized lane. In addition, according to the embodiment, it is possible to acquire an accurate position of an adjacent vehicle based on information on lanes other than the misrecognized lane. Thus, it is possible to more appropriately perform driving assistance according to the surrounding situation of the vehicle M.

The embodiment described above can be expressed as follows.
A driving assistance device including:
a storage medium that stores computer-readable instructions; and
a processor that is connected to the storage medium, wherein
the processor executes the computer-readable instructions to
recognize division lines for dividing a traveling path around a vehicle,
perform one or both of instructing a braking device of the vehicle to stop the vehicle when a degree of approach between the vehicle and a target object among objects in front of the vehicle satisfies a first condition with reference to an output of a detection device that detects the presence of the objects, and instructing a steering device of the vehicle to avoid coming into contact with the target object by steering,
perform a first preliminary operation when the degree of approach between the target object and the vehicle satisfies a second condition, and
perform a second preliminary operation when the degree of approach between the target object and the vehicle satisfies a third condition and when it is determined that there is no space where the vehicle is movable after performing avoidance by the steering to any traveling path on a side of the target object at a point in time when the third condition is satisfied,
the first condition is a condition that is satisfied when the degree of approach is higher than that of the second condition,
the second condition is a condition that is satisfied when the degree of approach is higher than that of the third condition, and
when it is determined that there is a misrecognized lane based on a lane width of a lane divided by two division lines among a plurality of recognized division lines, the traveling path on the side of the target object is specified based on information on the lane other than the misrecognized lanes.

Although the mode for implementing the disclosure has been described above using the embodiment, the disclosure is not limited to such an embodiment at all, and various modifications and substitutions can be made without departing from the gist of the disclosure.

### REFERENCE SIGNS LIST

10 Camera
12 Radar device
14 LIDAR
16 Object recognition device
80 Driving operator
100 Driving assistance device
110 Braking control part
112 First preliminary operation control part
120 Steering avoidance control part
130 Second preliminary operation control part
132 Steering avoidance possibility determination part
140 Division line recognition part
200 Traveling driving force output device
210 Brake device
220 Steering device

What is claim is:

1. A driving assistance device comprising:
a division line recognition part that recognizes division lines for dividing a traveling path around a vehicle;
a braking control part that instructs a braking device of the vehicle to stop the vehicle when a degree of approach between the vehicle and a target object among objects in front of the vehicle satisfies a first condition with reference to an output of a detection device that detects the presence of the objects; and
a steering avoidance control part that instructs a steering device of the vehicle to avoid coming into contact with the target object by steering, wherein
the braking control part includes a first preliminary operation control part that performs a first preliminary operation when the degree of approach satisfies a second condition,
the braking control part further includes a second preliminary operation control part that performs a second preliminary operation when the degree of approach satisfies a third condition and when it is determined that there is no space where the vehicle is movable after performing avoidance by the steering to any traveling path on a side of the target object at a point in time when the third condition is satisfied,
the first condition is a condition that is satisfied when the degree of approach is higher than that of the second condition,
the second condition is a condition that is satisfied when the degree of approach is higher than that of the third condition, and
when the second preliminary operation control part determines that there is a misrecognized lane based on a lane width of a lane divided by two division lines among a plurality of division lines recognized by the division line recognition part, the traveling path on the side of the target object is specified based on information on a lane other than the misrecognized lane.

2. The driving assistance device according to claim 1, wherein, when the lane width of the lane divided by the two division lines among the plurality of division lines recognized by the division line recognition part is less than a threshold value, one of the two division lines is deleted to recognize a lane, and the traveling path on the side of the target object is specified based on the recognized lane.

3. The driving assistance device according to claim 2, wherein the threshold value is a value that is set based on a lane width of a lane in which the vehicle travels.

4. The driving assistance device according to claim 1, wherein the second preliminary operation control part deletes a division line that is farther from the vehicle out of the two division lines when the lane width of the vehicle divided by the two division lines is less than the threshold value.

5. The driving assistance device according to claim 1, wherein the second preliminary operation control part deletes a division line with a lower degree of recognition which is recognized by the division line recognition part out of the two division lines when the lane width of the lane divided by the two division lines is less than the threshold value.

6. The driving assistance device according to claim 1, wherein the second preliminary operation control part deletes one division line based on line types of the two division lines when the lane width of the lane divided by the two division lines is less than the threshold value.

7. The driving assistance device according to claim 1, wherein the second preliminary operation is an operation that is started at an earlier timing than the first preliminary operation.

8. The driving assistance device according to claim 1, wherein at least one of the first preliminary operation and the second preliminary operation is an operation of instructing the braking device to output a braking force smaller than a braking force that the braking control part instructs the braking device to output.

9. The driving assistance device according to claim 1, wherein at least one of the first preliminary operation and the second preliminary operation is an operation of instructing an output device to perform a display, audio output, or vibration output for calling attention.

10. A driving assistance method comprising:
causing a driving assistance device to
recognize division lines for dividing a traveling path around a vehicle,
perform one or both of instructing a braking device of the vehicle to stop the vehicle when a degree of approach between the vehicle and a target object among objects in front of the vehicle satisfies a first condition with reference to an output of a detection device that detects the presence of the objects, and instructing a steering device of the vehicle to avoid coming into contact with the target object by steering,
perform a first preliminary operation when the degree of approach between the target object and the vehicle satisfies a second condition, and
perform a second preliminary operation when the degree of approach between the target object and the vehicle satisfies a third condition and when it is determined that there is no space where the vehicle is movable after performing avoidance by the steering to any traveling path on a side of the target object at a point in time when the third condition is satisfied, wherein
the first condition is a condition that is satisfied when the degree of approach is higher than that of the second condition,
the second condition is a condition that is satisfied when the degree of approach is higher than that of the third condition, and
when it is determined that there is a misrecognized lane based on a lane width of a lane divided by two division lines among a plurality of recognized division lines, the traveling path on the side of the target object is specified based on information on the lane other than the misrecognized lanes.

11. A non-transitory computer-readable storage medium that stores a program to be executed by a computer to perform at least:
recognize division lines for dividing a traveling path around a vehicle,
perform one or both of instructing a braking device of the vehicle to stop the vehicle when a degree of approach between the vehicle and a target object among objects in front of the vehicle satisfies a first condition with reference to an output of a detection device that detects the presence of the objects, and instructing a steering device of the vehicle to avoid coming into contact with the target object by steering,
perform a first preliminary operation when the degree of approach between the target object and the vehicle satisfies a second condition, and
perform a second preliminary operation when the degree of approach between the target object and the vehicle satisfies a third condition and when it is determined that there is no space where the vehicle is movable after performing avoidance by the steering to any traveling path on a side of the target object at a point in time when the third condition is satisfied, wherein
the first condition is a condition that is satisfied when the degree of approach is higher than that of the second condition,
the second condition is a condition that is satisfied when the degree of approach is higher than that of the third condition, and
when it is determined that there is a misrecognized lane based on a lane width of a lane divided by two division lines among a plurality of recognized division lines, the traveling path on the side of the target object is specified based on information on the lane other than the misrecognized lanes.
